(19) United States
(12) Patent Application Publication
(10) Pub. No.: US 2013/0217561 A1
(43) Pub. Date: Aug. 22, 2013

(54) Alkali-Free Glass for Flat Panel Display and Melting Process Thereof

(71) Applicants: Guohong Yang, Xianyang (CN); Zifa Duan, Xianyang (CN); Dacheng Wang, Xianyang (CN)

(72) Inventors: Guohong Yang, Xianyang (CN); Zifa Duan, Xianyang (CN); Dacheng Wang, Xianyang (CN)

(21) Appl. No.: 13/883,575

(22) PCT Filed: Nov. 9, 2010
(86) PCT No.: PCT/CN2010/001795

§ 371 Date: May 5, 2013

(51) Int. Cl. C03C 3/093

(52) U.S. Cl. CPC C03C 3/093
USPC 501/67; 65/29.1

(57) ABSTRACT

An alkali-free glass for flat panel display consists of, by weight, 54-68% SiO₂, 10.8-17.1% Al₂O₃, 7.6-12.5% B₂O₃, 0.2-1.8% MgO, 4.2-8% CaO, 0.6-7.1% SrO, 0.1-5% BaO, 0.2-1% ZnO, 0.01-1.54% ZrO₂ and 0.1-1.3% SnO+SnO₂. The boroaluminosilicate glass of the present invention does not contain As and Sb which contribute to serious environmental pollution. The quality of the glass is improved by the specific process which reduces the content of the gas inclusions in the glass.

### BACKGROUND OF THE PRESENT INVENTION

1. Field of Invention

The present invention belongs to the glass field, relates to an alkali-free boroaluminosilicate glass, and more particularly to a boroaluminosilicate glass for a flat panel display.

2. Description of Related Arts

A liquid crystal display (LCD) is formed by enclosing the liquid crystal between two glass substrates and applying a voltage to display. The substrates have two effects. The first effect is to keep a certain thickness of the liquid crystal. The second effect is to bear the transparent electrodes and the switching elements what are necessary to drive. A stringent interval with a size of 5-10 μm is provided between the two substrates.

To adapt to the development of the LCD technology, the substrate glass has various compositions, manufacturing modes and characteristics. The LCD is strict in the property of the substrate glass itself and the quality of the flat panel. The requirements of the LCD on the substrate glass are as follows.

The first is the dimensional accuracy. The manufacturing process of the display with high performance includes multiple precision photolithographies. It is required that the machining accuracy of the overall dimension of the substrate should reach the error of 1/10 mm. However, the most important thing is that it is very strict in the quality requirements on the surface flatness and the thickness. For example, if the accuracy of the two substrates of the active LCD can not be guaranteed, there will be a local error in the formed furnace space, namely, the distance between the two substrates, which will have a direct impact on the electric fields and the pixels, so that the grayscale and the color of the display are uneven. The substrate with low flatness in the photolithography process will also cause problems, for example, it can not focus on the entire plane while exposing, so that the circuit is defective. If the short-range printing is adopted, the warping substrate will damage the photomask. The flatness error of the substrate includes the simple warping, the waviness of the entire substrate and the molecular roughness with the size of the nanometer.

The second is heat resistance. It mainly refers to the temperature performance and heat shrinkable, which are intrinsically linked with each other. During the process of manufacturing the TFT, the substrate is repeatedly heat-treated. The p-SiTFT-type LCD with the highest temperature is heated to 625° C. at most, it is required that the substrate should maintain rigidity at this temperature without any viscous flow phenomenon, otherwise, the deformation of the glass and the decreasing temperature will bring not only thermal stress, but various sizes. The glass only has the above-mentioned property at the temperature which is lower than the strain temperature Tst. Therefore, it is required that the Tst of the substrate glass should be higher than 625° C., added with the insurance amount of 25° C., Tst of the glass is more than 650° C. Researches show that even if the temperature is lower than Tst, due to structure relaxation, the size of the substrate is still changed.

During the manufacturing process, the temperature of the display is multiply, repeatedly and quickly increased and decreased, it is inevitable that the structure of the glass is relaxed and the size thereof is changed, thus the lithographic plate making electronic circuit has the deviation. Therefore, it is required that the contraction size of the entire substrate element only be a fraction of the thinnest line width in the circuit diagram, namely, a few microns. For the display with the size of hundreds of millimeters, the contraction allowable amount is only a few millionths. To improve the resolution, the line width of the circuit diagram of the display is getting smaller, but the size of the display is getting bigger. In spite that the automatic compensation technology can compensate for the heat shrinkable deviation in lithography, the low heat shrinkage is still the necessary condition.

The third is the chemical stability. It is required that the substrate glass withstand various chemical treatments in the manufacturing process of the display. For example, the a-Si active matrix LCD has the thin film circuits which are more than seven layers and the same amount of etching steps, the etchant and the cleaning agent can be strong acid and strong alkali, such as more than 10% NaOH, more than 10% H₂SO₄, concentrated HNO₃, 10% HF-HNO₃, and concentrated H₃PO₄. It can be said that the requirement of the substrate for the chemical stability is almost the most stringent in the glass varieties.

The fourth is the external and internal defects. The substrate must have high surface quality and internal quality, the edge-face of the manufacturing circuit has no scratches and stains, the defect should be less than a few microns, so as to avoid damaging the circuit. It is allowable that the internal bubbles and inclusions are as small as one fraction of the pixel. The maximum allowable limit of the defect area is 25% of a single pixel area. For a display with the pixel size of 100 μm, the inclusion with the size of 50 μm is allowed.

The fifth is the Alkali restriction. In the manufacturing process of the eigenmatrix LCD, the thermal processing temperature is lower than 350° C., the soda-lime glass substrate can be used, a layer of SiO₂ barrier plated on the surface can prevent Na⁺ from migrating into the circuit, which has been widely used. However, if the thermal processing temperature is close to Tst, it is difficult for the barrier layer to have enough ability to prevent the migration of Na⁺. For the non-eigenmatrix LCD, namely, the active matrix LCD, because the α-Si or p-Si device is manufactured on the substrate, the thermal processing temperature is quite high, and especially, the thermal processing temperature of the p-Si device is higher than that of the α-Si device. The thermal processing temperature mainly depends on the technology of manufacturing the thin film transistor TFT device. It is required that the temperature of coating the gate dielectric material SiNx should be higher than 600° C. At this time, Na⁺ from the substrate may pass through the barrier layer. Therefore, the Alkali content of this kind of LCD substrate is as low as possible, preferably, zero.

U.S. Pat. Nos. 5,811,361, 5,851,939 and 6,329,310 disclosed that the substrate glass for TFT-LCD must have basic physical properties as follows.

1. To reduce the destroy caused by the thermal expansion and contraction of the substrate glass at the production temperature of TFT-LCD substrate, the thermal expansion coefficient of the glass must be low enough, in general, be less than 40×10⁻⁷/° C.

2. The volume shrinkage and the instability of the size of the substrate glass caused by reheating at the production temperature of TFT-LCD substrate should be reduced. It is required that the strain point of the glass should be higher than 650° C.

3. To meet the need of the increasingly lightweight of the large-size flat panel display, it is required that the density of the glass should be less than 2.6 g/cm³, and the lighter the better.

Furthermore, with the development of the direct of LCD to large-size, high-definition and high-brightness for adapting to the need of the market, the TFT-LCD crystal substrate glass has more excellent performances.

Because the LCD adopts the “back through” irradiation method for displaying, the light-emitting utilization of the backlight is low, the brightness is not as good as CRT, PDP and OLED display technologies. The LCD is committed to improve the brightness. Therefore, the improved light transmittance of the liquid crystal substrate glass can play its role better. Currently, the light transmittance of the mainstream substrate glass reaches 90%.

With the larger size of the LCD, to reduce the production cost, the area of the glass substrate becomes bigger and bigger. It is easily achieved that the area of the substrate with the thickness of less than 1 mm can reach more than 1 m². Some manufacturers even reach 6 m². In the use and transport, due to the gravity, such a thin glass substrate is sagged and easily broken. The sagging problems produced by the glass substrate with thin and large size bring a certain difficulties to the production of the substrate. Therefore, the bending strength of the glass substrate is improved, so that the deformation of the glass substrate does not occur or occurs less by the external force or self-gravity, which is helpful to reduce the breaking the glass substrate and also more conductive to the transport of the substrate glass and the production of the panel manufacturers.

Currently, in the several maturing methods of producing the substrate glass of LCD, the overflow molding method is the most popular. The surface grinding of the following process is unnecessary for the substrate glass produced by the overflow molding method. However, the controlling requirement of the technology for the production process is very high. It is required that the flow rate, the temperature and the pull of the clip edge machine should be controlled synchronously and accurately. Slight change may lead to the overlarge pull of the clip edge machine, so that the glass substrate is snapped. Once the glass substrate is snapped, it always needs a long time to re-lead the substrate, thus the production efficiency and the production yield are reduced. Therefore, the substrate glass of the LCD also needs higher bending strength to avoid the snapping of the substrate during the overflow molding production process.

In recent years, with the large-scale and ultra large-scale trend of the liquid crystal panel display, the lightweight of the TFT active matrix liquid crystal display is required, the substrate tends to thinning. Therefore, it is required that the strength of the substrate should be improved and the weight of the glass is reduced for achieving the lightweight.

In general, to reach various characteristics required by the substrate glass of the liquid crystal display, such as the expansion rate is lower than 40×10⁻⁷/° C., the strain point is higher than 650° C., the density is lower than 2.6 g/cm³, the selected alkali-free glass basically belongs to the RO-Al₂O₃-B₂O₃-SiO₂ system glass.

Due to increasingly environmental protection demand, As₂O₃, Sb₂O₃ and other clarifying agents are gradually limited to be used. Currently, the European Union and other countries have prohibited arsenic-containing products from entering the EU market. The present invention is committed to achieve the product without As and Sb.

To ensure that the bubble inclusions produced during the production process of the glass can be smoothly discharged, according to Stokes law, the speed of the bubble in the glass solution rising to the surface is inversely proportional to the viscosity of the glass solution, namely, V=2 r2 g(ρ−ρ′)/9η, wherein V-the floating up speed of the bubble, r-the radius of the bubble, g-the gravitational acceleration, ρ-the density of the glass, ρ′-the density of the gas in the bubble, η-the viscosity of the glass solution. Therefore, it is hoped that the viscosity of the glass solution, and especially, the viscosity at high temperature thereof is as low as possible.

The gas inclusion (bubble) is the main glass defects. Its source is more complex, including the air generated by the gap when the batch melts, the gas generated by the decomposition of various compounds, and the gas evolved by the reaction container materials (such as refractories). Historically, these gas inclusions are eliminated by arsenic or antimony as the clarifying agent. However, the two substances harmful to the environment and health, the present invention is committed to produce the glass with the very low content of arsenic or antimony, preferably, the glass without arsenic or antimony. The quantitative indicators of the impacts of the gas inclusions on the product quality are as follows. The content of the gas inclusions in the glass (the glass substrate) produced commercially should be less than or equal to one gas inclusion/kg glass (the diameter of the gas inclusion is larger than 0.5 mm is regarded as the defect). For the glass with the quality of at least 1 kg, preferably, the content of the gas inclusion in the glass is less than 0.5 gas inclusions/kg glass. For the glass with the quality of at least 2 kg, preferably, the content of the gas inclusion in the glass is less than 0.3 gas inclusions/kg glass. Of course, the value is as small as possible.

### SUMMARY OF THE PRESENT INVENTION

An object of the present invention is to provide an alkali-free glass with low density, low expansion coefficient, high strain point, high chemical stability, high bending strength, and high light transmittance, and without harmful substances As₂O₃ and Sb₂O₃.

An object of the present invention is to overcome the shortcomings of the above-mentioned prior art and provide an alkali-free glass for flat panel display. The glass, by weight, consists of 54-68% SiO₂, 10.8-17.1% Al₂O₃, 7.6-12.5% B₂O₃, 0.2-1.8% MgO, 4.2-8% CaO, 0.6-7.1% SrO, 0.1-5% BaO, 0.2-1% ZnO, 0.01-1.54% ZrO₂ and 0.1-1.3% SnO+SnO₂.

The mass percentage of MgO+SrO+BaO in the glass is 0-12%.

The light transmittance of the glass is 93-97.

The strain point of the glass is 650-685° C.

The expansion coefficient of the glass in the range of 0-300° C. is 30×10⁻⁷/° C.-40×10⁻⁷/° C.

The liquidus temperature of the glass is 1110-1210° C.

The density of the glass is 2.300-2.550 g/cm³.

A method of preparing an alkali-free boroaluminosilicate glass comprises steps as follows.

(1) By weight, the raw material formula of the glass consists of 54-67% SiO₂, 13-18% Al₂O₃, 7-12% B₂O₃, 0-1.8% MgO, 3-10% CaO, 0.2-8% SrO, 0.1-7% BaO, 0.001-1.5% ZnO, 0.001-1.0% ZrO₂ and 0.01-1.0% clarifying agent.

(2) Completely react the raw material formula of the glass in the first container made of the non-metallic refractory at 1500-1620° C. for 4 hours to obtain the glass solution, and put the glass solution into the second container.

(3) Insulate the glass solution in the second container at 1640° C. for 40-75 minutes, and then at 1600° C. for 40-120 minutes.

(4) Put the solution obtained in step (3) into the metal template for cooling to be plate-like and then annealing for obtain the alkali-free boroaluminosilicate glass. The thermal expansion coefficient of the glass at the temperature of 0-300° C. is 28-39×10⁻⁷/° C., the density thereof≦2.5 g/cm³, the elastic modulus thereof≧70 GPa.

In the wavelength range of 500-650 nm, the light transmittanceof the alkali-free glass is more than 93%, the bending strength thereof is more than 110 MPa, the strain point thereof is more than 650° C. The thermal expansion coefficient is 28-39×10⁻⁷/° C. at the temperature of 0-300° C., the liquidus temperature is less than 1250° C., the density is 2.35-2.55 g/cm³, the elastic modulus is more than 70 GPa, and the viscosity value at the liquidus temperature is higher than 15000 Poises.

In the present invention, by controlling the content of SrO+BaO+MgO and the ratio of CaO/(SrO+BaO+MgO), the bending strength of the glass is further improved to more than 110 MPa, preferably, more than 118 MPa, optimally, more than 130 MPa, thus reducing the deformation of the glass plate with large size during the production process.

### DETAILED DESCRIPTION OF THE PREFERRED EMBODIMENT

The alkali-free glass of the present invention has the glass network structure formed by SiO₂, B₂O₃ and Al₂O₃, wherein SiO₂+B₂O₃+Al₂O₃≧80%, ΣRO (R is Mg, Ca, Sr, Ba or Zn)/Al₂O₃ is 0.9-1.2 (which is weight ratio). Si is the main component for forming the glass network. Al³⁺ can enter the glass network as [AlO₄] tetrahedron when free oxygen is supplied by RO. Si⁴⁺ is a tetravalent ion, Al³⁺ is a trivalent ion, the electrovalence will be unbalanced when Al³⁺ replaces Si⁴⁺, so the metal ions are attracted to occupy the network gap for increasing the integrity and strength of the network. Therefore, the viscosity and the softening point of the glass are improved.

While free oxygen is insufficient, the general intermediate ions approximately enter the network in the following order: [BeO₄]→[AlO₄]→[GaO₄]→[BO₄]→[TiO₄]→[ZnO₄]. Therefore, when ΣRO (R is Mg, Ca, Sr, Ba, Be or Zn)/Al₂O₃ is 0.9-1.2, Al³⁺ becomes tetrahedron, B forms [BO₃] triangular body and plays a regulation role, thereby avoiding the overhigh melting temperature. Preferably, ΣRO/Al₂O₃ is 0.9-1, optimally, is 0.96-1.

In the present invention, the content of SiO₂ is 54-67%. The improvement of the content of SiO₂ is helpful to the lightweight, low thermal expansion coefficient, chemical resistance of the glass. However, the high-temperature viscosity will be increased, which goes against the production. Therefore, the content of SiO₂ is set to 54-68%.

The content of Al₂O₃ is 13-18%, preferably, is 15-18%. The high-content Al₂O₃ is helpful to improve the strain point and the bending strength of the glass. However, if the content of Al₂O₃ is too high, the glass will be easily crystallized.

B₂O₃ plays a special role. It can separately generate the glass. Under the melting condition of high temperature, it is difficult for B₂O₃ to form [BO₄]. It can reduce high-temperature viscosity. At low temperature, B is also inclined to gain the free oxygen for forming [BO₄], so that the structure becomes close, the low-temperature viscosity of the glass is improved, thereby avoiding the crystallization. However, if B₂O₃ is excessive, the strain point of the glass will be reduced. Therefore, the best content of B₂O₃ is 7-12%, preferably, 8-12%.

MgO is the network modifier. Only there is no Al₂O₃, B₂O₃ and other oxides, Mg enters the network as [MgO₄]. If MgO is excessive, the glass will be loosen, the density of the glass will be reduced, and the hardness thereof will be reduced. MgO can also reduce the crystallization tendency and the crystallization rate, and improve the chemical stability and the mechanical strength of the glass. However, its content should not be too much, otherwise, the glass is easily crystallized and the coefficient of expansion is overhigh. MgO, introduced in the present invention, plays another important role in making up for the change of the material property (viscosity-temperature characteristics) caused by the increased content of CaO in the embodiment. The content of MgO is 0-1.8%, preferably, 0-<1%.

The effect of CaO is similar to that of MgO. Ca has the accumulation effect on the structure of the glass. CaO can adjustably reduce the high-temperature viscosity and significantly improve the melting property of the glass without reducing the strain point of the glass. The excessive CaO will reduce the chemical resistance of the glass. Here, the content of CaO is 3-10%, preferably, 4-9%.

In the RO-SiO₂-B₂O₃-Al₂O₃ system glass, the function of CaO is also reflected in the effect of the changing ratio of CaO/(SrO+BaO+MgO) on the bending strength of the glass. Ca, Mg, Sr, Ba as RO oxygen agents enter the glass together, ΣRO/Al₂O₃ is determined in a certain range. If the content of CaO is reduced, SrO and BaO must be added into the glass instead of CaO. However, when the ratio of CaO/(SrO+BaO+MgO) is changed, the bending strength of the glass will have an extreme. According to the experiment, the ratio of CaO/(SrO+BaO+MgO) is controlled in the range of 0.3 to 6, preferably, 0.3 to 2, optimally, 0.3-0.8, thus the bending strength of the glass can be improved to exceed 110 MPa, preferably, to exceed 118 MPa, optimally, to exceed 130 MPa.

Both SrO and BaO can improve the chemical resistance and the anti-crystallization of the glass. However, massive SrO and BaO will increase the density and the expansion coefficient of the glass. Both SrO and BaO have the components which are capable of specially improving the chemical resistance of the glass. The entire content of the components must be more than 0.2% or even higher. To improve the chemical resistance, the content of SrO and BaO is preferably as high as possible. However, for the density and the expansion coefficient of the glass, it is hoped that the content of SrO and BaO is preferably as low as possible. Therefore, it is necessary for the content of SrO and BaO to be controlled in a certain range. The content of SrO is 0.2-8%, and that of BaO is 0.1-7%. The content of SrO+BaO should be controlled in the range of 1% to 10%, preferably, 2-9%, optimally, 2-6%.

ZnO can reduce the high-temperature viscosity of the glass, improve the chemical resistance thereof, and reduce the thermal expansion coefficient thereof. However, if ZnO is too much, the strain point of the glass will be reduced.

ZrO₂ can effectively improve the chemical stability of the glass, reduce the expansion coefficient thereof and significantly increase the elastic modulus thereof. However, due to small solubility of ZrO₂ in the glass, the high-temperature viscosity and the liquidus temperature of the glass are increased, thereby increasing the crystallization tendency. ZrO₂ is also helpful to improve the acid resistance, the elasticity, the bending strength and the heat expansion of the glass.

The content of Fe³⁺, Cl⁻ and S²⁻ should be as low as possible in the substrate glass of the liquid crystal display (LCD). In the present invention, it is required that Fe³⁺<0.3%, Cl⁻<10 ppm, S²⁻<0.3%, preferably, Fe³⁺<0.1%, Cl⁻<19 ppm, S²⁻<0.1%, optimally, Fe³⁺<0.05%, Cl⁻<10 ppm, S²⁻<0.05%.

The present invention is further explained in detail with the embodiments as follows. However, the purpose of the data is to explain and example, but not to limit the present invention in any way.

Tables 1-3 are some examples of the present invention. These examples are dosed according to the composition requirement. The weight of every material is 300 kg. The above-mentioned raw material is sufficiently evenly mixed and then put into the container 1 made of refractory material. By using Joule heat, the temperature in the container 1 is increased to 1500-1600° C., and not more than 1620° C. After 4 hours, the material is put into the container 2 made of metal. By the electrodes, the temperature is increased to 1640° C., the material is maintained the temperature for about 60 minutes and not more than 75 minutes. And then the temperature of the container 2 is decreased to 1600° C. and maintained for 60 minutes and not more than 120 minutes. After maintaining the temperature, the glass solution is quickly put into the metal template for cooling to be plate-like (100 mm*200 mm*19 mm) and then is annealed. The bubble content of the glass sample is checked to obtain the elastic modulus, the weight loss, the bending strength, the temperature of the strain point, the liquidus temperature, the hardness, expansion coefficients and other characteristics.

TABLE 1

| | Example 1 | Example 2 | Example 3 | Example 4 | Example 5 | Example 6 | Example 7 |
|---|---|---|---|---|---|---|---|
| SiO₂ | 54.50 | 54.50 | 60.50 | 61.00 | 56.20 | 67.3 | 58.00 |
| Al₂0₃ | 17.00 | 17.10 | 12.10 | 11.90 | 16.00 | 10.9 | 14.00 |
| B₂O₃ | 11.00 | 11.10 | 10.00 | 9.58 | 11.80 | 8.5 | 12.50 |
| MgO | 1.80 | 1.70 | 0.56 | 0.70 | 1.20 | 0.40 | 1.02 |
| CaO | 7.90 | 7.40 | 6.70 | 6.50 | 6.80 | 4.6 | 5.20 |
| SrO | 7.10 | 6.60 | 4.60 | 4.20 | 5.00 | 2.7 | 5.20 |
| BaO | 0.10 | 1.30 | 4.00 | 4.40 | 2.09 | 2.8 | 2.98 |
| ZnO | 0.20 | 0.00 | 0.40 | 0.45 | 0.32 | 0.60 | 0.36 |
| ZrO₂ | 0.10 | 0.15 | 0.54 | 0.62 | 0.24 | 1.30 | 0.30 |
| SnO+ | 0.20 | 0.25 | 0.60 | 0.65 | 0.35 | 0.90 | 0.44 |
| SnO₂ | | | | | | | |
| MgO | 9.20 | 9.60 | 9.16 | 9.30 | 8.30 | 5.90 | 9.22 |
| +SrO | | | | | | | |
| +BaO | | | | | | | |
| CaO/(MgO+ | 0.88 | 0.77 | 0.73 | 0.70 | 0.82 | 0.78 | 0.57 |
| SrO+Ba) | | | | | | | |
| Light | 92 | 95 | 93 | 90 | 93 | 93 | 96 |
| Transmittance | | | | | | | |
| (T550) | | | | | | | |
| Strain point | 638 | 640 | 654 | 656 | 650 | 665 | 652 |
| (° C.) | | | | | | | |
| Expansion | 39.10 | 39.15 | 36.21 | 36.32 | 38.80 | 37.60 | 38.70 |
| coefficient | | | | | | | |
| (×10⁻⁷/° C.) | | | | | | | |
| Bending | 116 | 117 | 120 | 119 | 116 | 116 | 123 |
| strength | | | | | | | |
| (MPa) | | | | | | | |
| Liquidus | 1120 | 1125 | 1125 | 1128 | 1158 | 1152 | 1165 |
| temperature | | | | | | | |
| (° C.) | | | | | | | |
| Density | 2.6450 | 2.6370 | 2.5520 | 2.5310 | 2.5970 | 2.3620 | 2.5740 |
| (g/cm³) | | | | | | | |
| Elastic | 72 | 72 | 73 | 76 | 70 | 75 | 74 |
| Modulus | | | | | | | |
| (GPa) | | | | | | | |
| Amount of | 0.20 | 0.50 | 0.30 | 0.70 | 0.20 | 0.80 | 0.20 |
| bubbles/Kg | | | | | | | |
| glass | | | | | | | |

TABLE 2

| | Example 8 | Example 9 | Example 10 | Example 11 | Example 12 | Example 13 | Example 14 |
|---|---|---|---|---|---|---|---|
| SiO₂ | 58.30 | 67.5 | 67.8 | 55.00 | 55.60 | 61.60 | 61.00 |
| Al₂0₃ | 12.80 | 12.5 | 13.2 | 17.00 | 16.80 | 11.50 | 12.00 |
| B₂O₃ | 10.20 | 8.45 | 7.6 | 11.20 | 11.30 | 9.40 | 8.00 |
| MgO | 0.46 | 0.88 | 0.20 | 1.40 | 1.30 | 0.76 | 0.80 |
| CaO | 8.00 | 4.9 | 4.7 | 7.30 | 7.00 | 6.00 | 15.0 |
| SrO | 6.00 | 1.6 | 0.6 | 5.70 | 5.30 | 4.10 | 2.65 |
| BaO | 3.00 | 1.8 | 2.3 | 1.60 | 1.80 | 4.75 | 0.10 |
| ZnO | 0.39 | 0.80 | 0.90 | 0.30 | 0.35 | 0.50 | 0.30 |
| ZrO₂ | 0.40 | 1.42 | 1.50 | 0.20 | 0.22 | 0.69 | 0.0 |
| SnO+ | 0.45 | 0.15 | 1.20 | 0.30 | 0.33 | 0.70 | 0.15 |
| SnO₂ | | | | | | | |
| MgO | 9.46 | 4.28 | 3.10 | 8.70 | 8.40 | 9.61 | 3.55 |
| +SrO | | | | | | | |
| +BaO | | | | | | | |
| CaO/(MgO | 0.85 | 1.14 | 1.52 | 0.84 | 0.83 | 0.62 | 4.2 |
| +SrO+Ba) | | | | | | | |
| Light | 91 | 93 | 93 | 92.5 | 93 | 94 | 93 |
| Transmittance | | | | | | | |
| (T550) | | | | | | | |
| Strain point | 648 | 667 | 667 | 645 | 649 | 657 | 646 |
| (° C.) | | | | | | | |
| Expansion | 36.41 | 36.54 | 36.51 | 38.80 | 38.82 | 36.25 | 42.80 |
| coefficient | | | | | | | |
| (×10⁻⁷/° C.) | | | | | | | |
| Bending | 120 | 109 | 105 | 118 | 118 | 124 | 101 |
| strength | | | | | | | |
| (MPa) | | | | | | | |
| Liquidus | 1140 | 1205 | 1170 | 1136 | 1160 | 1176 | 1179 |
| temperature | | | | | | | |
| (° C.) | | | | | | | |
| Density | 2.5700 | 2.3830 | 2.3820 | 2.6140 | 2.6120 | 2.5200 | 2.4900 |
| (g/cm³) | | | | | | | |
| Elastic | 76 | 73 | 75 | 75 | 76 | 77 | 76 |
| Modulus | | | | | | | |
| (GPa) | | | | | | | |
| Amount of | 0.20 | 0.90 | 1.10 | 0.30 | 0.30 | 0.40 | 0.20 |
| bubbles/Kg | | | | | | | |
| glass | | | | | | | |

TABLE 3

| | Example 15 | Example 16 | Example 17 | Example 18 | Example 19 | Example 20 | Example 21 |
|---|---|---|---|---|---|---|---|
| SiO₂ | 67.0 | 58.50 | 67.2 | 67.4 | 57.40 | 59.20 | 68.0 |
| Al₂0₃ | 11.0 | 12.30 | 11.5 | 10.8 | 14.70 | 12.50 | 8.1 |
| B₂O₃ | 8.6 | 10.40 | 8.9 | 9.0 | 12.20 | 10.00 | 12.0 |
| MgO | 0.45 | 0.48 | 0.34 | 0.35 | 1.09 | 0.52 | 0.16 |
| CaO | 4.8 | 7.80 | 4.2 | 5.0 | 5.60 | 7.40 | 4.9 |
| SrO | 3.0 | 5.60 | 2.6 | 1.9 | 5.40 | 5.20 | 2.9 |
| BaO | 3.0 | 3.64 | 2.5 | 2.6 | 2.61 | 3.78 | 0.1 |
| ZnO | 0.55 | 0.36 | 0.64 | 0.70 | 0.34 | 0.40 | 1.00 |
| ZrO₂ | 0.82 | 0.42 | 1.20 | 1.30 | 0.26 | 0.47 | 1.54 |
| SnO+ | 0.78 | 0.50 | 0.92 | 0.95 | 0.40 | 0.53 | 1.30 |
| SnO₂ | | | | | | | |
| MgO | 6.45 | 9.68 | 5.45 | 4.85 | 9.09 | 9.52 | 3.15 |
| +SrO | | | | | | | |
| +BaO | | | | | | | |
| CaO/(MgO | 0.74 | 0.81 | 0.77 | 1.04 | 0.62 | 0.77 | 1.56 |
| +SrO+Ba) | | | | | | | |
| Light | 95 | 95 | 92 | 93 | 93 | 94 | 93 |
| transmittance | | | | | | | |
| (T550) | | | | | | | |
| Strain point | 665 | 649 | 666 | 665 | 650 | 652 | 668 |
| (°C.) | | | | | | | |
| Expansion | 37.80 | 36.38 | 36.50 | 36.52 | 38.74 | 36.24 | 36.53 |
| coefficient | | | | | | | |
| (×10⁻⁷/° C.) | | | | | | | |
| Bending | 115 | 114 | 113 | 109 | 118 | 117 | 107 |
| strength | | | | | | | |
| (MPa) | | | | | | | |
| Liquidus | 1210 | 1100 | 1185 | 1191 | 1162 | 1120 | 1200 |
| temperature | | | | | | | |
| (° C.) | | | | | | | |
| Density | 2.4900 | 2.5690 | 2.3850 | 2.3830 | 2.5860 | 2.5620 | 2.3810 |
| (g/cm³) | | | | | | | |
| Elastic | 75 | 78 | 76 | 78 | 71 | 75 | 74 |
| modulus | | | | | | | |
| (GPa) | | | | | | | |
| Amount of | 0.70 | 0.30 | 0.70 | 0.70 | 0.20 | 0.40 | 0.80 |
| bubbles/Kg | | | | | | | |
| glass | | | | | | | |

The above descriptions further explain the present invention combined with the specifically preferred embodiments in detail. It can not be identified that the specific embodiments of the present invention are limited thereto. For one skilled in the technical field of the present invention, without departing from the concept of the present invention, some simple deductions or replacements can be made, which should be regarded as the protection range claimed by the submitted claims of the present invention.

What is claimed is:

1. An alkali-free glass for flat panel display, characterized in that, by weight, the glass consists of 54-68% SiO₂, 10.8-17.1% Al₂O₃, 7.6-12.5% B₂O₃, 0.2-1.8% MgO, 4.2-8% CaO, 0.6-7.1% SrO, 0.1-5% BaO, 0.2-1% ZnO, 0.01-1.54% ZrO₂ and 0.2-1.3% SnO+SnO₂.

2. The alkali-free glass for flat panel display, as recited in claim 1, characterized in that the mass percentage of MgO+SrO+BaO in the glass is 0-12%.

3. The alkali-free glass for flat panel display, as recited in claim 1, characterized in that the light transmittance of the glass is 93-97.

4. The alkali-free glass for flat panel display, as recited in claim 1, characterized in that the strain point of the glass is 650-685° C.

5. The alkali-free glass for flat panel display, as recited in claim 1, characterized in that the expansion coefficient of the glass in the range of 0-300° C. is 30×10⁻⁷/° C.-40×10⁻⁷/° C.

6. The alkali-free glass for flat panel display, as recited in claim 3, characterized in that the liquidus temperature of the glass is 1110-1210° C.

7. The alkali-free glass for flat panel display, as recited in claim 1, characterized in that the density of the glass is 2.300-2.550 g/cm³.

8. A method of preparing the alkali-free boroaluminosilicate glass as recited in claim 1, characterized by comprising steps of:
(1) by weight, forming a raw material formula of the glass which consists of 54-67% SiO₂, 13-18% Al₂O₃, 7-12% B₂O₃, 0-1.8% MgO, 3-10% CaO, 0.2-8% SrO, 0.1-7% BaO, 0.001-1.5% ZnO, 0.001-1.0% ZrO₂ and 0.01-1.0% clarifying agent;
(2) completely reacting the raw material formula of the glass in a first container made of the non-metallic refractory at 1500-1620° C. for 4 hours to obtain a glass solution, and then put the glass solution into a second container;
(3) insulating the glass solution in the second container at 1640° C. for 40-75 minutes, and then at 1600° C. for 40-120 minutes; and
(4) putting the solution obtained in step (3) into a metal template for cooling to be plate-like and then annealing for obtain the alkali-free boroaluminosilicate glass.
